(19) United States
(12) Patent Application Publication
(10) Pub. No.: US 2008/0112460 A1
(43) Pub. Date: May 15, 2008

(54) Detecting intaglio print

(75) Inventors: Scott L. Colston, Dundee (GB); Gary A. Ross, Midlothian (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/598,995

(22) Filed: Nov. 14, 2006

(51) Int. Cl. G01K 13/00

(52) U.S. Cl. 374/141; 374/E13.001

(57) ABSTRACT

We describe detecting intaglio print on banknotes such that potentially counterfeit banknotes are identified by the absence of intaglio print or the presence of incorrect intaglio print. Intaglio print comprises ridges and grooves on a substrate where ink is applied only to the ridges. A thermal sensor is used to detect the presence of intaglio print by, for example, presenting a banknote to the thermal sensor and moving the banknote relative to that sensor. The banknote may be swiped past the sensor or vice versa. A comparison is made between the output of the thermal sensor and pre-specified information about intaglio printed regions associated with the printed item. Counterfeit detection may also be carried out for passports, postage stamps and other intaglio printed items.

### TECHNICAL FIELD

This description relates generally to a method and apparatus for detecting counterfeit printed items. It is particularly related to, but in no way limited to, detecting counterfeit printed items such as banknotes, passports, postage stamps or other items by detecting intaglio print.

### BACKGROUND

There is a growing need for automatic detection of potentially counterfeit banknotes of different currencies and denominations in a simple, reliable, and cost effective manner. This is required, for example, in self-service apparatus which receives banknotes, such as self-service kiosks, ticket vending machines, automated teller machines arranged to take deposits, self-service currency exchange machines and the like.

Previously, manual methods of currency validation have involved image examination, transmission effects such as watermarks and thread registration marks, feel and even smell of banknotes. Other known methods have relied on semi-overt features requiring semi-manual interrogation. For example, using magnetic means, ultraviolet sensors, fluorescence, infrared detectors, capacitance, metal strips, image patterns and similar. However, by their very nature these methods are manual or semi-manual and are not suitable for many applications where manual intervention is unavailable for long periods of time. For example, in self-service apparatus.

The complexity of counterfeit banknotes is improving and some counterfeit banknotes now simulate security features such as UV fluorescence, water marks or magnetic features. Other methods of detecting counterfeit banknotes are thus required that are suitable for machine reading. Any such method needs to be cost effective, fast, reliable and robust.

It is also required to provide automated methods for detecting counterfeit passports, postage stamps or other printed items.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

We describe detecting intaglio print on banknotes such that potentially counterfeit banknotes are identified by the absence of intaglio print or the presence of incorrect intaglio print. Intaglio print comprises ridges and grooves on a substrate where ink is applied. A thermal sensor is used to detect the presence of intaglio print by, for example, presenting a banknote to the thermal sensor and moving the banknote relative to that sensor. The banknote may be swiped past the sensor or vice versa. A comparison is made between the output of the thermal sensor and pre-specified information about intaglio printed regions associated with the printed item. Counterfeit detection may also be carried out for passports, postage stamps and other intaglio printed items.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a flow diagram of a method of automatically detecting a counterfeit printed item;

FIG. 2 is a schematic diagram of an apparatus for automatically detecting a counterfeit printed item;

FIG. 3 is a flow diagram of a method of analyzing intaglio print;

FIG. 4a is a representation of part of a banknote having intaglio printed regions;

FIG. 4b is a thermal sensor output for part of the banknote of FIG. 4a;

FIG. 4c is a thermal sensor output for another part of the banknote of FIG. 4a;

FIG. 5 is a schematic diagram of an apparatus for presenting a banknote to a thermal sensor within a self-service apparatus such as an automated teller machine;

FIG. 6 shows the apparatus of FIG. 5a with a counterfeit banknote indicated schematically.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in an automated teller machine for counterfeit banknote detection, the methods and systems described are provided as an example and not a limitation. As those skilled in the art will appreciate, the present examples are suitable for application in a variety of different types of counterfeit item detection systems, including for passports, postage stamps and other items having intaglio print.

Intaglio is a printmaking technique that is currently used to print the majority of genuine banknotes in the world. In the US banknotes are intaglio printed on both sides. In other regions such as the UK and the Euro zone banknotes are intaglio printed on one side only at present although this may change to both sides in the near future. Because the intaglio printmaking technique requires extremely expensive, heavy plant machinery and because it requires extremely skilled hand etching of print plates it is very rare for counterfeit banknotes to be produced using this technique. We provide a method and apparatus for detecting intaglio print on banknotes such that potentially counterfeit notes are identified by the absence of intaglio print or the presence of incorrect intaglio print.

Intaglio printing involves making grooves in metal printing surfaces such as copper or zinc plates or cylinders. The grooves are formed in any suitable manner, for example, by etching with acid, engraving or other methods. Typically, fine precision and accuracy is used when forming the grooves making the resulting pattern difficult to replicate exactly. Ink, which is extremely viscous, is applied inside the grooves, for example by covering the printing surface in ink and then removing the ink from all but the grooves. Banknote substrate such as paper is then applied to the printing surface under high pressure (for example, tens of tons of pressure) and the ink is transferred from the grooves or recesses of the plate to the paper. As a result of the high pressure and the viscosity of the ink as well as other factors the regions of paper to which ink is applied are raised up relative to the rest of the paper. This leads to the characteristic “feel” of a banknote which is often used by individuals in a manual test of authenticity of a banknote.

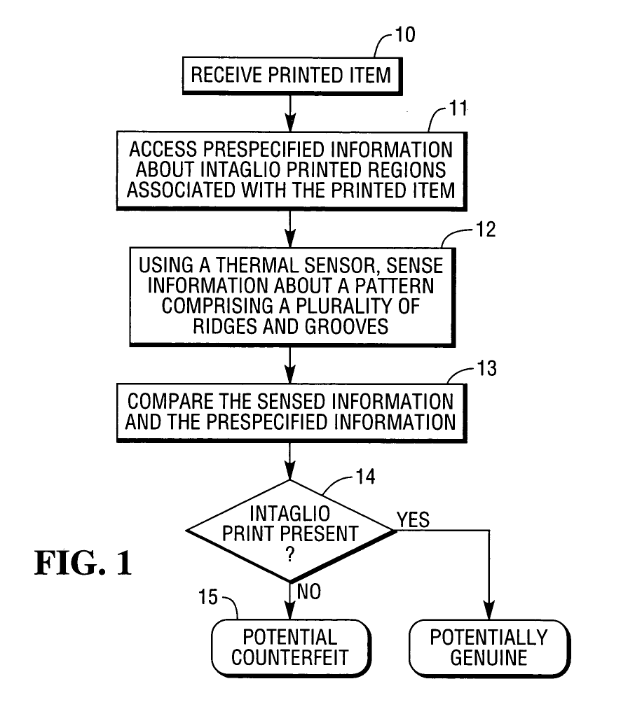

FIG. 1 is a flow diagram of a method of automatically detecting a counterfeit printed item. The printed item is received 10 using any suitable input means such as a conventional banknote input means from an automated teller machine or a machine reader input means for a passport. Pre-specified information about intaglio printed regions (and possibly also other regions printed using other techniques) associated with the printed item is accessed 11. For example, this information may be available from a memory or database integral with the counterfeit detection apparatus or may be accessed from a distributed or remote source in communication with the apparatus. A thermal sensor is used 12 to sense information about a pattern comprising a plurality of ridges and grooves on the printed item. The thermal sensor may be used to sense information from the whole printed item or only pre-specified regions of that item. In the case of banknotes, the thermal sensor may be arranged to sense information from both sides or only one side of the banknote. The sensed information is then compared 13 with the pre-specified information using a processor of any suitable type. As a result of the comparison a decision process 14 is achieved. If no intaglio print is detected the item is identified as a potential counterfeit 15. If intaglio print is detected, the process may either output a result indicating that the printed item is thought to be genuine or may proceed to further analysis of the detected intaglio print.

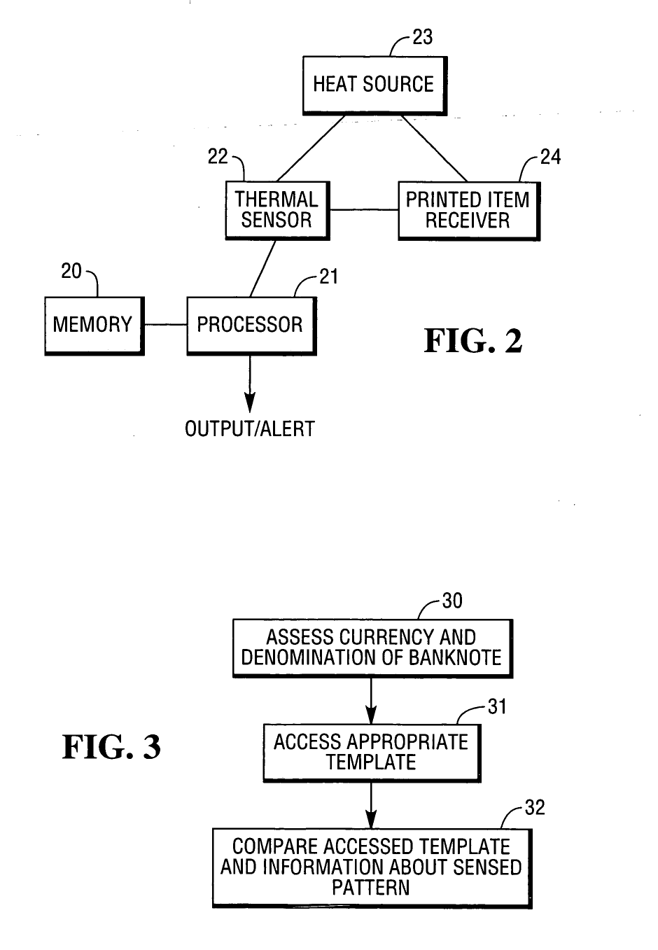

FIG. 2 is a schematic diagram of an apparatus for detecting counterfeit printed items. It comprises a printed item receiver 24 for accepting a printed item to be assessed and a thermal sensor 22, positioned such that the printed item may be received and presented to the thermal sensor. The thermal sensor is of any suitable type for detecting intaglio print. For example, a thermal finger print swipe sensor may be used such as that commercially available from Atmel (trade mark). The thermal sensor may comprise a plurality of sensor elements sensitive to heat and arranged to measure temperature differences between those sensor elements. The sensor elements may be provided as a linear array or as a 2D array. We have found that this type of thermal swipe finger print sensor is very successful at sensing intaglio print. As an intaglio printed item is presented to the sensor and swiped or moved across that sensor, the contact from the surface of the intaglio print is typically a different temperature from the ambient air temperature trapped in the grooves or valleys between the raised print. These differences in temperature between the ridges and grooves of intaglio print are detected as differences in temperature between the sensor elements.

It is not essential for the printed item to be swiped or moved across the sensor in the case that a 2D sensor is used comprising a 2D array of sensor elements. In the case that a linear array of sensor elements is used the printed item may be moved across that linear array to detect intaglio print over a 2D area of the printed item.

The apparatus optionally comprises a heat source 23 of any suitable type such as an electric heating element, heating light source or other heat providing means. The heat source is arranged to provide heat either to the printed item or to the printed item indirectly via the sensor.

The heat source is used to exaggerate the thermal gradient between ridges and grooves of the intaglio print. This enables a better signal to be obtained by the thermal sensor which gives a better signal to noise ratio and improves accuracy.

The apparatus optionally comprises a memory 20 which stores pre-specified information about intaglio printed regions associated with the printed item. This memory may be integral with the apparatus or provided remotely in communication with the apparatus. Alternatively, the apparatus accesses this information from an independent source.

A processor is provided 21 which may be a computer or any other suitable type of processor. This processor is arranged to access the pre-specified information from the memory 20 and to receive sensed information from the thermal sensor 22. It is also arranged to make a comparison between these two inputs and to detect counterfeit printed items on the basis of that comparison. The processor may be arranged to generate an alert in the case that a potential counterfeit is detected. If the processor is provided as part of a self-service apparatus, automated teller machine, or other apparatus the alert may also comprise an action to disable that apparatus.

In one embodiment the pre-specified information simply comprises an indication that intaglio print is expected to be present. The comparison stage may then comprise a simple thresholding process to assess whether the sensed information comprises a signal or only noise. If a signal is present then intaglio print is assumed to be present and the printed item is potentially genuine. Otherwise, if no signal is present, a potential counterfeit is identified.

In another embodiment, the pre-specified information comprises a template or other 2D representation of a pattern of intaglio print expected to be found on the printed item. In this case, the comparison step comprises performing a pattern matching process to compare information about a pattern detected by the thermal sensor with the template. Any suitable pattern matching process can be used such as a correlation process or feature matching process.

In another embodiment (see FIG. 3), the apparatus is arranged to operate for a plurality of different currencies or denominations of banknote. In this case, information is accessed 30 to determine the currency and/or denomination of the banknote using any suitable known method. For example, optical detection, size detection or other means. An appropriate template is accessed 31 for that currency and denomination, the template having information about expected intaglio print patterns. The comparison step 32 then proceeds with the accessed template and information about the sensed pattern obtained as described above. Alternatively, where no information about the currency and denomination is available, the comparison step comprises making comparisons with a plurality of templates for different currencies and denominations.

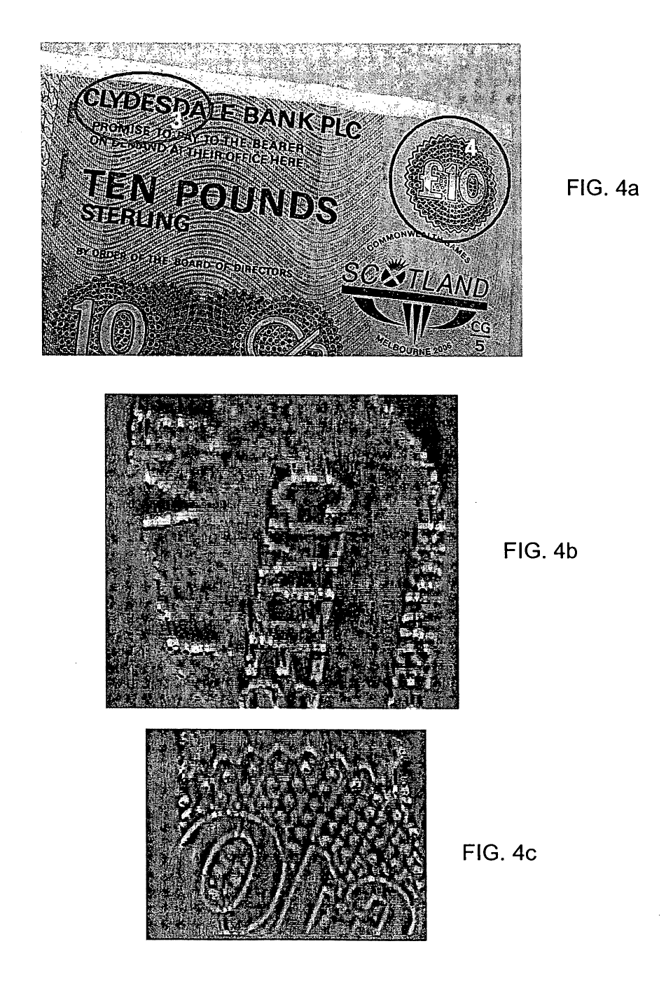

FIG. 4a shows a region of a banknote with two ringed regions 3, 4 comprising intaglio print. FIG. 4b shows an example output from a thermal swipe sensor in which it can be seen that intaglio print is detected from region 3 of the banknote of FIG. 4a. FIG. 4c shows an example output from a thermal swipe sensor for region 4 of the banknote of FIG. 4a.

In FIG. 4a part of a Scottish banknote is illustrated in grayscale with region 3 comprising text in block capitals, that text being printed using intaglio techniques. In region 4 the text £10 is shown against a generally circular patterned background. Region 4 is also printed using intaglio techniques. FIG. 4b shows the output in grayscale from a thermal swipe sensor obtained for region 3. A laterally inverted image of the block capital text is visible with high contrast regions indicating intaglio print and regions of substantially similar grayscale indicating non intaglio print regions. FIG. 4c shows the output in grayscale from the thermal swipe sensor obtained for part of region 4c. A laterally inverted image of the £10 text and patterned region is shown in high contrast against a relatively uniform grey background.

In another embodiment, in which a heat source 23 is used to apply heat to a banknote immediately prior to presentation to the thermal sensor 22 other regions of the banknote are detected which may not be intaglio printed areas. For example, these are any regions which lose heat at different rates to the air as compared with the banknote substrate. For example, threads, holograms, hot foil stamps, watermarks, or the like. In this case, the pre-specified information preferably also comprises information about thermal sensor profiles for other regions of printed items, besides intaglio printed regions.

The pre-specified information, templates and thermal sensor profiles may be obtained from an independent source or may be created during a calibration type process using printed items known to be genuine.

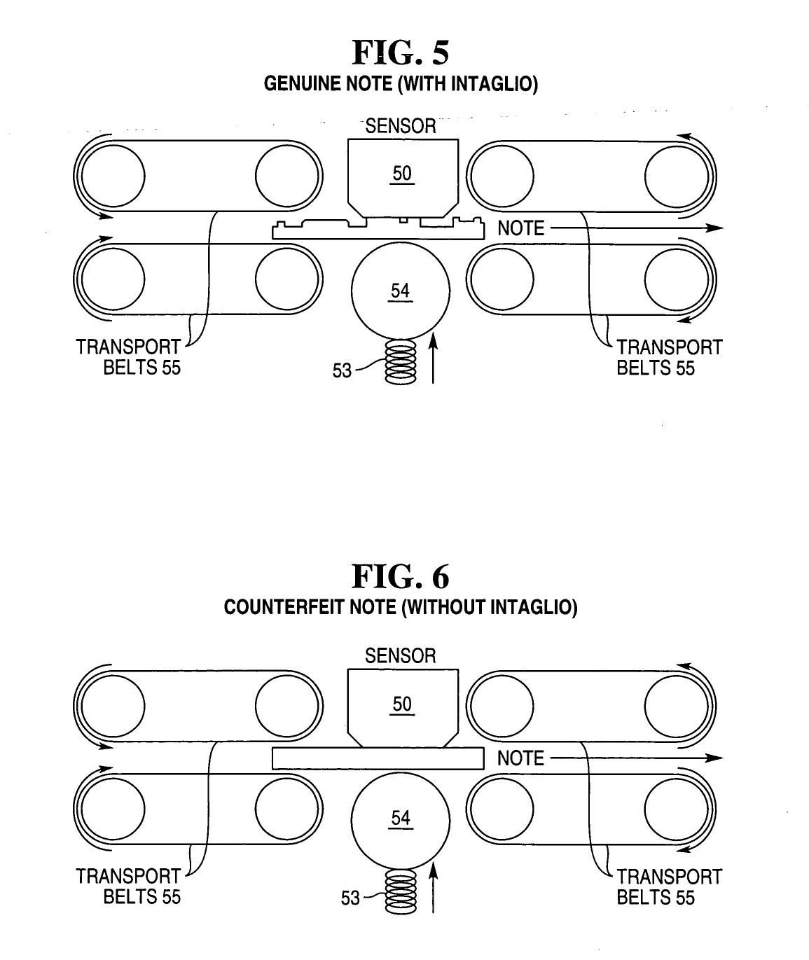

In some embodiments the apparatus is provided integral with a self-service apparatus or automated teller machine arranged to accept banknotes. FIG. 5 shows an arrangement inside an automated teller machine for presenting a banknote to a thermal sensor. Pairs of transport belts 55 mounted in parallel on rollers are provided to support banknotes such as banknote 51 illustrated schematically as having intaglio print on one surface. The transport belts move in the directions indicated by arrows such that the banknotes are driven through the apparatus in the direction of arrow 52. The transport belts thus drive the banknotes through a sensor area, that is, between sensor 50 and roller 54. The roller 54 is spring mounted against the sensor 50 using spring 53 as indicated or using any other means to bias the roller 54 against the sensor 50. The sensor comprises a thermal sensor as described above with reference to FIG. 2. The spring mounted roller 54 may be heated using a heat source (not shown). FIG. 6 illustrates the same apparatus with a counterfeit banknote 60 having no intaglio print.

In the example described with reference to FIGS. 5 and 6 the banknote is moved past the sensor. However, this is not essential. The sensor may be moved across the banknote instead. Alternatively, a sensor with a 2D array may be used which does not required relative movement between the sensor and banknote or other printed item.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Some of the methods described herein may be performed by software in machine readable form on a storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. It will further be understood that reference to ‘an’ item refer to one or more of those items.

The steps of the methods described herein may be carried out in any suitable order, or simultaneously where appropriate.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

What is claimed is:

1. A method of automatically detecting a counterfeit printed item comprising:—
(i) accessing pre-specified information about intaglio printed regions associated with the printed item;
(ii) using a thermal sensor to sense information about a pattern comprising a plurality of ridges and grooves on the printed item;
(iii) comparing the information about the pattern and the pre-specified information and, on the basis of the comparison, assessing whether the printed item is potentially counterfeit.

2. A method as claimed in claim 1 wherein the thermal sensor is arranged to detect relative temperature differences between ridges and grooves formed by intaglio printing.

3. A method as claimed in claim 1 wherein the method further comprises receiving the printed item and moving the printed item relative to the sensor during the step of sensing the information.

4. A method as claimed in claim 1 which further comprises applying heat to the printed item immediately before carrying out the step of sensing the information.

5. A method as claimed in claim 1 which further comprises providing heat at the sensor.

6. A method as claimed in claim 1 wherein the printed item is any of: a banknote, a passport, and a postage stamp.

7. A method as claimed in claim 4 wherein the pre-specified information also comprises information about heat profiles associated with non-intaglio printed regions of the printed item and wherein the step of using the sensor further comprises sensing heat profiles from the printed item.

8. An apparatus for automatically detecting a counterfeit printed item comprising:—
(i) an input arranged to access pre-specified information about intaglio printed regions associated with the printed item;
(ii) a thermal sensor arranged to sense information about a pattern comprising a plurality of ridges and grooves on the printed item;
(iii) a processor arranged to compare the information about the pattern and the pre-specified information and, on the basis of the comparison, assess whether the printed item is potentially counterfeit.

9. An apparatus as claimed in claim 8 wherein the thermal sensor comprises an array of sensor elements sensitive to heat and wherein the thermal sensor is arranged to detect temperature differences between the sensor elements.

10. An apparatus as claimed in claim 8 which comprises an input arranged to receive the printed item and a support arranged to present the printed item to the sensor and to move it past the sensor.

11. An apparatus as claimed in claim 8 which further comprises a heat source arranged to apply heat to the printed item.

12. An apparatus as claimed in claim 10 wherein the heat source is integral with the sensor.

13. An apparatus as claimed in claim 8 wherein the printed item is any of: a banknote, a passport, and a postage stamp.

14. An apparatus as claimed in claim 11 wherein the pre-specified information also comprises information about heat profiles associated with non-intaglio printed regions of the printed item and wherein the sensor is arranged to sense heat profiles from the printed item

15. An apparatus as claimed in claim 8 which is integral with any of an automated teller machine, a self-service kiosk, an automated currency exchange machine and a ticket vending machine.

16. One or more computer readable media storing computer executable instructions for carrying out a method comprising:
(i) accessing pre-specified information about intaglio printed regions associated with the printed item;
(ii) receiving inputs from a thermal sensor comprising information about a pattern comprising a plurality of ridges and grooves on the printed item;
(iii) comparing the information about the pattern and the pre-specified information and, on the basis of the comparison, assessing whether the printed item is potentially counterfeit; and
(iv) if the printed item is assessed as being potentially counterfeit, generating an alert.
